(19) United States
(12) Patent Application Publication
(10) Pub. No.: US 2010/0095238 A1
(43) Pub. Date: Apr. 15, 2010

(54) Device, Method, Computer Program Product and User Interface for Enabling a User to Vary Which Items are displayed to the user

(76) Inventor: Gilles Baudet, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/992,104

(22) PCT Filed: Sep. 14, 2005
(86) PCT No.: PCT/IB2005/003160

§ 371 Date: Dec. 15, 2009

(51) Int. Cl. G06F 3/048

(52) U.S. Cl. 715/784

(57) ABSTRACT

An electronic device comprising: a display that is controllable to display at least a portion of an arrangement of items; and a user input that is usable to select a first subset of the arrangement of items and is usable to scroll the selected first subset within the displayed portion of the arrangement of items relative to a second subset of the arrangement of items.

### CROSS REFERENCE TO RELATED APPLICATIONS

This application is the U.S. National Stage of International Application Number PCT/IB05/003160 filed on Sep. 14, 2005 which was published in English on Mar. 22, 2007 under International Publication Number WO 2007/031816.

### FIELD OF THE INVENTION

Embodiments of the present invention relate to a device, method, computer program product and user interface for enabling a user to vary which items are displayed to the user. In particular, embodiments of the present invention relate to a device, method, computer program product and user interface for enabling a user to display one or more particular items of a plurality of items, when there is insufficient space to display the plurality of items.

### BACKGROUND TO THE INVENTION

There is a trend in the electronics industry towards increasing the features provided by electronic devices so that the end-user perceives the electronic device as a more desirable product.

There is also a trend in the electronics industry towards the miniaturization of electronic devices, so that they can, for example, be carried and used in the hand of a user.

As an example, in the field of mobile cellular radio telecommunications it is now common to have mobile cellular telephone terminals that also provide other functions such as, for example, Calendar, Contacts, Text composition, Image viewing, Image capture, Spreadsheets etc.

As a mobile cellular telephone terminal is typically hand-portable, there may be difficulties in providing a large number of functions via a relatively small display size.

In particular, if a graphical user interface is used for function selection, there may be difficulties in displaying an icon for each function simultaneously on the screen for selection as the number of functions increases.

It would be desirable to provide a novel user interface that enables a user to display selected ones of a plurality of items when there is insufficient space to display the plurality of items.

### BRIEF DESCRIPTION OF THE INVENTION

According to one embodiment of the invention there is provided an electronic device comprising: a display that is controllable to display at least a portion of an arrangement of items; and a user input that is usable to select a first subset of the arrangement of items and is usable to scroll the selected first subset within the displayed portion of the arrangement of items relative to a second subset of the arrangement of items.

According to another embodiment of the invention there is provided a method of controlling a display of an electronic device comprising: controlling the display to display at least a portion of an arrangement of items; receiving a first user input that selects a first subset of the arrangement of items; receiving a second user input for scrolling the selected first subset within the displayed portion of the arrangement of items, controlling the display to scroll the selected first subset relative to a second subset of the arrangement of items.

According to another embodiment of the invention there is provided a computer program product for controlling a user interface of an electronic device comprising program instructions which when loaded into a processor: control a display to display at least a portion of an arrangement of items; enable user selection of a first subset of the arrangement of items; enable user controlled scrolling of the selected first subset within the displayed portion of the arrangement of items, by controlling the display to scroll the selected first subset relative to a second subset of the arrangement of items.

According to another embodiment of the invention there is provided a user interface comprising: a display that displays a portion of an arrangement of items; and a user input that is usable to select a first subset of the arrangement of items and is usable to scroll the selected first subset within the displayed portion of the arrangement of items relative to a second subset of the arrangement of items.

Embodiments of the invention provide the advantage that a user has simple access to more items than can be displayed on the page at any one time. This is particularly advantageous in devices with small displays that are required to display a large amount of items or in devices, for the visually impaired, which display oversized items for easier recognition.

Furthermore, in embodiments of the invention, the user is able to configure the content of the displayed portion of the arrangement of items by separately scrolling different subsets of the arrangement so that the displayed portion comprises the items of most interest to the user. For example, if the subset is a column of the arrangement, a column of the arrangement may be separately scrolled by the user so that the content of the items in the displayed portion is as desired by the user.

### BRIEF DESCRIPTION OF THE DRAWINGS

For a better understanding of the present invention reference will now be made by way of example only to the accompanying drawings in which:

FIG. 1 schematically illustrates an electronic device;

FIG. 2 schematically illustrates a method for scrolling a selected subset within a displayed portion of an arrangement of items; and

FIGS. 3A, 3B and 3C schematically illustrate the independent scrolling of separately selected columns;

FIGS. 4A, 4B and 5C schematically illustrate the independent scrolling of separately selected rows; and

FIGS. 5A, 5B and 5C schematically illustrate one example embodiment in which a column of icons is selected and scrolled.

### DETAILED DESCRIPTION OF EMBODIMENTS OF THE INVENTION

The following paragraphs describe, with reference to the Figures, examples of an electronic device 10 that comprises: a display 16 that is controllable to display a portion 40 of an arrangement 42 of items 44; and a user input 12 that is usable to select a first subset 46 of the arrangement 42 of items 44 and is usable to scroll the selected first subset 46 within the displayed portion 40 of the arrangement of items relative to a second subset of the arrangement of items.

In the described example that follows, the first subset is scrolled within a stationary second subset. However, it should be appreciated that this is not essential as there are other ways of achieving relative scrolling movement between the first and second subsets. For example, the second subset may not be stationary but may move more slowly in the same direction or move in the opposite direction to that in which the selected first subset moves. As another example, the first selected subset may remain stationary while the second subset moves in the opposite direction to the direction of scrolling. In this example, the selected first subset, although stationary, scrolls relative to the second subset in the direction of scrolling.

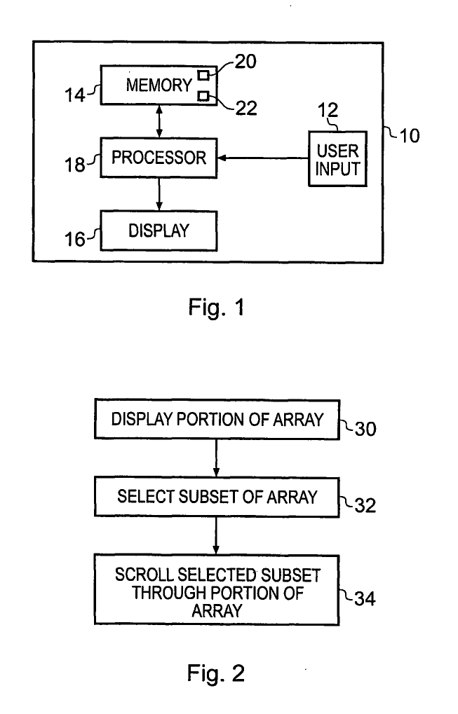

FIG. 1 schematically illustrates an electronic device 10. Only the features referred to in the following description are illustrated. It should, however, be understood that the device 10 may comprise additional features that are not illustrated. The electronic device 10 may be, for example, a personal computer, a personal digital assistant, a mobile telephone, a television, a video recorder in combination with a television, an mp3-player or any other music player, or any other electronic device that uses a graphical user interface.

The illustrated electronic device 10 comprises: a user input 12, a memory 14, a display 16 and a processor 18. The processor 18 is connected to receive input commands from the user input 12 and to provide output commands to the display 16. The processor 18 is also connected to write to and read from the memory 14.

The user input 12 is used for selection and scrolling as described below. It may be a single device such as a joystick, a touch screen, roller, mouse, track-ball etc. or a plurality of separate devices.

The memory 14 stores computer program product instructions 20, which when loaded into the processor 18, enable the processor 16 to control the operation of the device 10 as described below. The computer program product instructions 20 provide the logic and routines that enables the electronic device 10 to perform the methods illustrated in FIG. 2.

The computer program product instructions 20 may arrive at the electronic device 10 via an electromagnetic carrier signal or be copied from a physical entity 22 such as a computer program product, a memory device or a record medium such as a CD-ROM or DVD.

The memory 14 additionally stores data 22 that defines the plurality of items 44. The plurality of items may be arranged, for example, within an N column by M row array 42. An item 44 may be, for example, a selectable item such as an icon in a graphical user interface (GUI) menu that has a plurality of icons or a non-selectable item such as a data string in a spreadsheet.

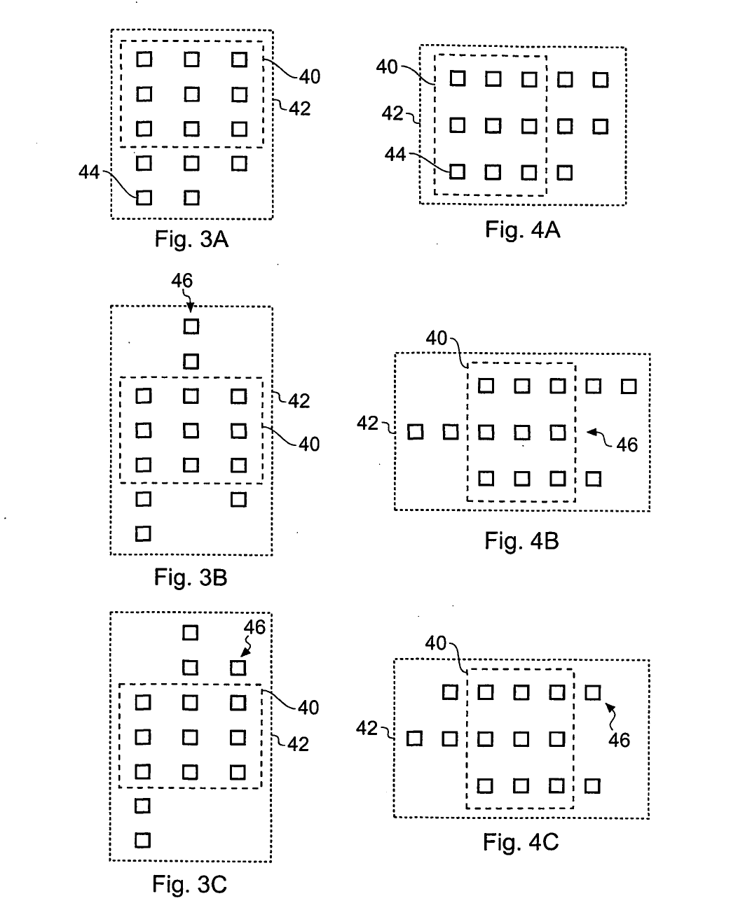

The display 16 may not be able to simultaneously display the whole of the plurality 42 of items simultaneously. This is because the ratio of item size to display size does not enable all of the items to be displayed. This may be because a small display is used with typically sized items, for example, in a hand-portable device or because a larger display with oversized items is used, for example to assist the visually impaired or because there are more items than the display can handle. The display therefore displays a portion 40 of the plurality 42 of items 44 at any one time as illustrated in FIGS. 3A, 3B and 3C and FIGS. 4A, 4B and 4C.

As illustrated in FIG. 2, the display displays 30 a portion 40 of the arrangement 42 of items 44. The user of the device 10 selects 32 a subset 46 of the arrangement 42 of items using the user input 12. The user of the device 10 then scrolls 34 the selected subset 46 using the user input 12 while the unselected displayed items 44 remain stationary in the display 16.

For example, referring to FIGS. 3A, and 3B, if the arrangement 42 comprises items arranged within an N column×M row array and only an array 40 of N columns×m rows is displayable at a time, where m<M, then the user of the device 10 is able to select one or more columns 46 of the arrangement of items and scroll the selected column(s) while the unselected columns remain stationary.

As illustrated in FIG. 3B, the second column is selected and scrolled up twice independently of the first and third columns. Then, separately, as illustrated in FIG. 3C, the third column is separately selected and scrolled up once independently of the first and second columns. The user is therefore able to configure the content of the displayed array 40 of items 44, by scrolling each column individually. The scrolling may be performed using a vertical scrollbar that runs parallel to the columns. Alternatively it may be performed in some other way.

The items within each column c are in a fixed and predetermined order that may be defined by the sequence S_{c} (xᵢ; i=1, 2, 3 . . . M_{c}), where M_{c} is the number of items in the column c. The items displayed in column c within the portion 40 are a sub-sequence of sequence S_{c} and may be defined by (xᵢ; i=α, α+1, α+2, . . . α+A), where α is 1, 2, 3 . . . and A is determined by the size of the portion 40 relative to the size of the items 44. ‘Scrolling’ changes the value of α.

As another example, referring to FIGS. 4A and 4B, if the arrangement comprises items arranged within an N column×M row array 42 and only an array 40 of n columns×M rows is displayable at a time, where n<N, then the user of the device 10 is able to select one or more rows 46 of the arrangement 42 of items and scroll the selected row(s) 46 while the unselected rows remain stationary.

As illustrated in FIG. 4B, the second row is selected and scrolled left twice independently of the first and third rows. Then, separately, as illustrated in FIG. 4C, the third row is then separately selected and scrolled left once independently of the first and second rows. The user is therefore able to configure the content of the displayed array 40 of items 44, by scrolling each row individually. The scrolling is preferably performed using a horizontal scrollbar that runs parallel to the rows.

The items within each row r are in a fixed and predetermined order that may be defined by the sequence Sᵣ (xᵢ; i=1, 2, 3 . . . Nᵣ), where N_{c} is the number of items in the row c. The items displayed in row r within the portion 40 are a sub-sequence of sequence Sᵣ and may be defined by (xᵢ; i=α, α+1, α+2, . . . a+B), where a is 1, 2, 3 . . . and B is determined by the size of the portion 40 relative to the size of the items 44. ‘Scrolling’ changes the value of α.

The user of the device 10 selects the subset 46 of the arrangement 42 of items using the user input 12. The user input 12 may be any suitable device or mechanism. For example, the subset 46 may be selected using a cursor control device such as a joystick or mouse that allows a part of the displayed array 40 to be delineated and selected, or it may be selected using a touch screen that allows items to be selected individually or a row/column at a time. For example, each column/row may have a widget at its heading, the selection of which selects the whole column/row.

The selected subset 46 of the arrangement 42 of items may then be highlighted so that it can be differentiated from the unselected items in the displayed portion of the arrangement.

The user of the device 10 scrolls the selected subset 46 of the arrangement of items using the user input 12 while the unselected displayed items in the displayed portion remain stationary. The same user input commands are provided using the same input device irrespective of which subset 46 is selected. An input device may be a single scroll bar 50 in which a widget 52 is moved along a bar 54. The same scrollbar 50 can be used for every possible selected subset of items. The scrollbar advantageously provides visual feedback to the user so that they know how much scrolling has occurred so far.

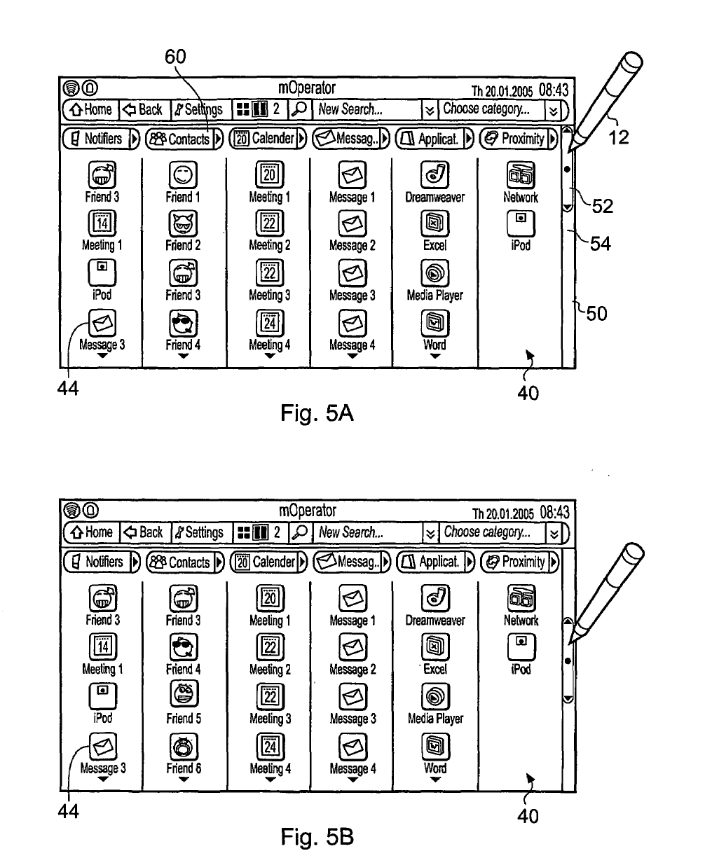

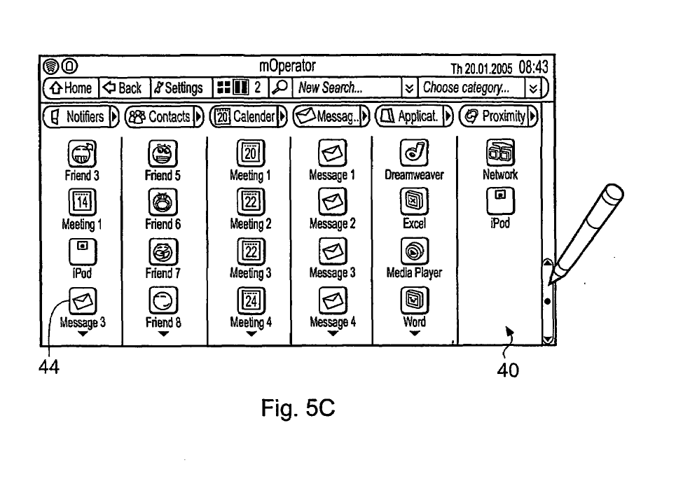

One example embodiment of the invention will now be described with reference to FIGS. 5A, 5B and 5C.

In this example, the plurality of items 44 are user selectable icons in a GUI menu. The icons 44 are arranged as six distinct columns. The display is however only capable of displaying an array of six columns by four rows of items at a time.

The user uses the user input 12 to select the ‘Contacts’ column of items 44. In this example, the user input 12 is the combination of a stylus and a touch screen. Each column has a widget 60 displayed at its heading. Touching a widget with the stylus selects the column headed by the widget. In this example, the selected widget includes the text ‘Contacts’.

The selection of the ‘Contacts’ column is indicated by changing the color of the widget 60 heading the column.

The selected contacts column is then scrolled by using a scrollbar 50. The scrollbar 50 comprises a widget 52 that is moved along a bar 54. The widget may be moved by touching it using the stylus and dragging the stylus along the bar 54 while it contacts the touch screen.

The length of the widget 52 relative to the length of the bar 54 gives an indication of the number of items within the selected column. In this example, there are eight items within the column so the widget is relatively long compared to the length of the bar 54. However, if another column were selected that has a greater number of items in it, such as the Calendar column, for example, then ratio of the length of the widget to the length of the bar would be considerably less.

As can be seen from FIGS. 5A, 5B and 5C, the position of the widget 52 along the length of the bar indicates the number of items that are available to be scrolled into the displayed portion 40.

If the user were to select the ‘Calendar’ column by tapping the widget 60 heading the column using the stylus, that column would be selected. The same scrollbar 50 that was previously used to scroll the ‘Contacts’ column would now be used to scroll the ‘Calendar’ column.

Although embodiments of the present invention have been described in the preceding paragraphs with reference to various examples, it should be appreciated that modifications to the examples given can be made without departing from the scope of the invention as claimed. For example, the individual selection for scrolling of row(s)/column(s) may be used as an aid for the visually impaired. In this embodiment, the user selects an option that enables the individual selection for scrolling of row(s)/column(s). The user is then able to specify the size of the items 44 relative to the displayed portion 40.

In the foregoing examples, as illustrated in FIGS. 3A-3C, the number of columns in the displayed portion 40 is the same as the number of columns in the arrangement 42 of items. In other embodiments, the number of columns in the arrangement 42 of items may be greater than the number of columns in the displayed portion 40. In this case a horizontal scrollbar may be provided for scrolling the columns of the arrangement 42 within the displayed portion 40. Thus for example, columns 1, 2 and 3 may be displayed or columns 2, 3 and 4 may be displayed or columns 3, 4 and 5.

The ordering of items within a column may be varied by dragging and dropping one item at a time within the column. The ordering of columns within the displayed portion 40 may be varied by dragging and dropping a whole column. A column may be dragged and dropped by dragging and dropping the widget 60 heading that column.

In the foregoing examples, as illustrated in FIGS. 4A-4C, the number of rows in the displayed portion 40 is the same as the number of rows in the arrangement 42 of items. In other embodiments, the number of rows in the arrangement 42 of items may be greater than the number of rows in the displayed portion 40. In this case a vertical scrollbar may be provided for scrolling the rows of the arrangement 42 within the displayed portion 40. Thus for example, rows 1, 2 and 3 may be displayed or rows 2, 3 and 4 may be displayed or rows 3, 4 and 5.

The ordering of items within a rows may be varied by dragging and dropping one item at a time within the row. The ordering of rows within the displayed portion 40 may be varied by dragging and dropping a whole row. A row may be dragged and dropped by dragging and dropping the widget heading that row.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An electronic device comprising:
a display that is controllable to display at least a portion of an arrangement of items; and
a user input that is usable to select a first subset of the arrangement of items and is usable to scroll the selected first subset within the displayed portion of the arrangement of items relative to a second subset of the arrangement of items.

2. The electronic device as claimed in claim 1, wherein the second subset comprises those items in the displayed portion of the arrangement of items that are not comprised in the selected first subset.

3. The electronic device as claimed in claim 1, wherein the second subset of items remains substantially stationary while the selected first subset is scrolled.

4. The electronic device as claimed in claim 1, wherein the first subset is a column of the arrangement of items that is scrollable independently of other columns of the arrangement of items.

5. The electronic device as claimed in claim 1, wherein the first subset is a plurality of columns of the arrangement of items that are scrollable independently of other columns of the arrangement of items.

6. The electronic device as claimed in claim 4, wherein the arrangement of items has N columns of items and the displayed portion has N columns of items, where N is a positive integer greater than one.

7. The electronic device as claimed in claim 1, wherein the first subset is a row of the arrangement of items that is scrollable independently of other rows of the arrangement of items.

8. The electronic device as claimed in claim 1, wherein the subset is a plurality of rows of the arrangement of items that are scrollable independently of other rows of the arrangement of items.

9. The electronic device as claimed in claim 7, wherein the arrangement of items has M rows of items and the displayed portion has M rows of items; where M is a positive integer greater than one.

10. The electronic device as claimed in claim 1, wherein the selected first subset is highlighted in the display.

11. The electronic device as claimed in claim 1, wherein a same user input command is used to scroll the selected first subset irrespective of the content of the selected first subset.

12. The electronic device as claimed in claim 1, wherein visual feedback is provided by the display that indicates the extent to which the selected first subset has been scrolled.

13. The electronic device as claimed in claim 1, wherein a single scrollbar, comprising a widget movable in a bar, is usable to scroll the selected first subset irrespective of the content of the selected first subset.

14. The electronic device as claimed in claim 1, wherein the items are icons in a graphical menu.

15. The electronic device as claimed in claim 1, wherein the display is controllable to display a portion of an arrangement of items, the user input is operable to select a first subset of the arrangement of items and is operable to scroll the selected first subset within the displayed portion of the arrangement, in response to an option selected by a user.

16. An electronic device, for the visually impaired, comprising:
a display that is controllable to display at least a portion of an arrangement of items;
and a user input that is usable to select a first subset of the array of items and is usable to scroll the selected first subset within the displayed portion of the arrangement of items relative to a second subset of the arrangement of items.

17. The electronic device as claimed in claim 16, wherein the second subset comprises those items in the displayed portion of the arrangement of items that are not comprised in the selected first subset.

18. The electronic device as claimed in claim 16, wherein the second subset of items remains substantially stationary while the selected first subset is scrolled.

19. The electronic device as claimed in claim 16, wherein the displayed portion comprises a number of items and the number of items is controllable by a user.

20. The electronic device, as claimed in claim 1, sized for hand portability and use.

21. A method of controlling a display of an electronic device comprising:
controlling the display to display at least a portion of an arrangement of items;
receiving a first user input that selects a first subset of the arrangement of items;
receiving a second user input for scrolling the selected first subset within the displayed portion of the arrangement of items, and
controlling the display to scroll the selected first subset relative to a second subset of the arrangement of items.

22. A readable memory stored with program instructions which when loaded into a processor:
control a display to display at least a portion of an arrangement of items;
enable user selection of a first subset of the arrangement of items by a user interface of an electronic device; and
enable user controlled scrolling by the user interface of the selected first subset within the displayed portion of the arrangement of items, by controlling the display to scroll the selected first subset relative to a second subset of the arrangement of items.

23. A user interface comprising:
a display that displays a portion of an arrangement of items;
and a user input that is usable to select a first subset of the arrangement of items and is usable to scroll the selected first subset within the displayed portion of the arrangement of items relative to a second subset of the arrangement of items.

24. (canceled)

25. (canceled)

26. An electronic device, for the visually impaired, comprising:
means for controllably displaying at least a portion of an arrangement of items;
means for user input selecting a first subset of the array of items and for scrolling the selected first subset within the displayed portion of the arrangement of items relative to a second subset of the arrangement of items.
